(19) United States
(12) Patent Application Publication
(10) Pub. No.: US 2026/0281310 A1
(43) Pub. Date: Sep. 17, 2026

(54) INTRA PREDICTION FUSION WITH INHERITED CROSS-COMPONENT MODELS

(71) Applicant: MEDIATEK INC., Hsinchu City (TW)

(72) Inventors: Chia-Ming TSAI, Hsinchu City (TW); Chih-Wei HSU, Hsinchu City (TW); Hsin-Yi TSENG, Hsinchu City (TW); Cheng-Yen CHUANG, Hsinchu City (TW); Yi-Wen CHEN, San Jose, CA (US); Ching-Yeh CHEN, Hsinchu City (TW); Tzu-Der CHUANG, Hsinchu City (TW)

(21) Appl. No.: 19/472,686

(22) PCT Filed: Jul. 17, 2024
(86) PCT No.: PCT/CN2024/105969

§ 371 Date: Oct. 5, 2025

Related U.S. Application Data
(60) Provisional application No. 63/513,904, filed on Jul. 17, 2023.

(51) Int. Cl. H04N 19/105; H04N 19/176

(52) U.S. Cl. CPC H04N 19/105; H04N 19/176

(57) ABSTRACT

A video coder specifies a cross-component prediction mode for a current block of a current picture of a video. The video coder derives a current cross-component model according to the specified cross-component mode for the current block. The video coder identifies a list of cross-component model candidates for the current block. The video coder selects a cross-component model candidate from the list of candidate cross-component models. The video coder generates a combined prediction based on the derived cross-component model and the selected cross-component model. The video coder encodes or decodes the current block by using the generated combined prediction. The video coder may signal a first syntax element indicating the specified cross-component prediction mode and a second syntax element indicating whether to use the combined prediction to encode the current block, with the first syntax element signaled before the second syntax element.

### CROSS REFERENCE TO RELATED PATENT APPLICATION(S)

The present disclosure is part of a non-provisional application that claims the priority benefit of U.S. Provisional Patent Application No. 63/513,904 filed on 17 Jul. 2023. Content of above-listed application is herein incorporated by reference.

### TECHNICAL FIELD

The present disclosure relates generally to video coding. In particular, the present disclosure relates to methods of coding pixel blocks by intra-prediction and cross-component prediction.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors (MVs) and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB corresponds to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list, reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a method of using combined cross-component prediction to encode or decode pixel blocks. A video coder specifies a cross-component prediction mode for a current block of a current picture of a video. The video coder derives a current cross-component model according to the specified cross-component mode for the current block. The video coder identifies a list of cross-component model candidates for the current block. The video coder selects a cross-component model candidate from the list of candidate cross-component models. The video coder generates a combined prediction based on the derived cross-component model and the selected cross-component model. The video coder encodes or decodes the current block by using the generated combined prediction.

The current cross-component model may be derived based on the neighboring reconstructed samples of the current block or predicted samples of the current block that are identified by the specified cross-component prediction mode. In some embodiments, the current cross-component model is set to be of a same cross-component prediction mode as that of the selected cross-component model.

In some embodiments, the video coder specifies a cross-component prediction mode for the current block. The cross-component prediction mode may be CCCM, CCLM, GLM, MMLM, or any other cross-component prediction mode. The video coder derives the current cross-component model according to the specified cross-component prediction mode for the current block. The video coder identifies the list of cross-component model candidates for the current block, then selects the cross-component model candidate from the list of candidate cross-component models.

The video coder may determine the specified cross-component prediction mode and whether to use the combined prediction to encode or decode the current block. In some embodiments, the determination is explicitly signaled by a first syntax element indicating the specified cross-component prediction mode and a second syntax element indicating whether to use the combined prediction to encode or decode the current block, wherein the first syntax element is signaled or parsed before the second syntax element. In some embodiments, the video coder may determine whether to use the combined prediction to encode or decode the current block based on a size constraint of the current block.

In some embodiments, when the combined prediction is used to encode or decode the current block, the first candidate in the list of candidates is the selected cross-component model candidate. In some embodiments, the specified cross-component prediction mode is implicitly derived.

In some embodiments, the video coder may determine whether the cross-component model candidate is used and whether to generate the combined prediction. In some embodiments, a first syntax element indicating whether to use the selected cross-component model candidate and a second syntax element indicating whether to use the combined prediction to encode or decode current block are explicitly signaled, with the first syntax element signaled before the second syntax element.

In some embodiments, when the selected cross-component model candidate and the current cross-component model are of the same cross-component prediction mode, the combined prediction is generated by computing weighted averages of model parameters of the selected cross-component model candidate and the current cross-component model.

The combined prediction may be a weighted sum of the first prediction and the second prediction. The weights assigned to the first and second predictions are predefined, determined by neighboring prediction modes, or implicitly derived by neighboring template cost.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 illustrates reconstruction of component samples using cross-component residual model (CCRM).

FIG. 2 conceptually illustrates inheriting temporal neighboring model parameters.

FIG. 3 conceptually illustrates neighboring templates of the current block.

FIG. 4 conceptually illustrates lists of candidates the current block and neighboring blocks.

FIG. 5 illustrates an example video encoder that may implement cross-component predictions.

FIG. 6 illustrates portions of the video encoder that implement combined cross-component predictions.

FIG. 7 conceptually illustrates a process for combining cross-component predictions.

FIG. 8 illustrates an example video decoder that may implement cross-component predictions.

FIG. 9 illustrates portions of the video decoder that implement combined cross-component predictions.

FIG. 10 conceptually illustrates a process for combining cross-component predictions.

FIG. 11 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Intra Prediction Modes

a. Directional Intra Modes

Intra-prediction method exploits one or more reference tiers adjacent to the current prediction unit (PU) and one of the intra-prediction modes to generate the predictors for the current PU. The Intra-prediction direction can be chosen among a mode set containing multiple prediction directions, DC mode, and Planar mode. The intra prediction mode may also refer to any intra mode which determines the predictor of the current block using the spatially reconstructed samples. The number of directional intra modes may be 33 or extended to 65 direction modes. By including DC and Planar modes, the number of intra-prediction mode is 35 (or 67). Some intra-prediction modes (e.g., 3 or 5) are identified as a set of most probable modes (MPM) for intra-prediction in current prediction block so an index may be signaled to select one of the MPMs.

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indices, which are remapped to indices of wide angular modes after parsing.

b. Decoder Side Intra Mode Derivation (DIMD)

To implicitly derive the intra prediction modes of a blocks, a texture gradient analysis is performed at both encoder and decoder sides. This process starts with an empty Histogram of Gradient (HoG) with 65 entries, corresponding to the 65 angular modes. Amplitudes of these entries are determined during the texture gradient analysis.

c. Template-Based Intra Mode Derivation (TIMD)

Template-based intra mode derivation (TIMD) mode implicitly derived the intra prediction mode of a CU by a neighboring template at both encoder and decoder, instead of being signal exact intra prediction mode bits to the decoder. The prediction samples of the template are generated using the reference samples of the template for each candidate mode. A cost is calculated as the SATD between the prediction and the reconstruction samples of the template. The intra prediction mode with the minimum cost is selected as the DIMD mode and used for intra prediction of the CU. The candidate modes may be 67 intra prediction modes as in VVC or extended to 131 intra prediction modes. In general, MPMs can provide a clue to indicate the directional information of a CU. Thus, to reduce the intra mode search space and utilize the characteristics of a CU, the intra prediction mode is implicitly derived from MPM list.

### II. Cross-Component Prediction

a. Cross-Component Linear Model (CCLM)

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β \qquad ( 1 )$$

where pred_{C}(i, j) represents the predicted chroma samples in a CU and rec_{L}(i, j) represents the downsampled reconstructed luma samples of the same CU. The CCLM parameters (α and β) are derived with at most four neighbouring chroma samples and their corresponding down-sampled luma samples. Suppose the current chroma block dimensions are W×H, then W″ and H′ are set as
W′=W, H′=H when LM_LA mode is applied
W′=W+H when LM_A mode is applied
H′=H+W when LM_L mode is applied;

The above neighbouring positions are denoted as S[0, −1] . . . . S[W′−1, −1] and the left neighbouring positions are denoted as S[−1, 0] . . . . S[−1, H′−1]. Then the four samples are selected as
S[W′/4, −1], S[3*W′/4, −1], S[−1, H′/4], S[−1, 3*H′/4] when LM_LA mode is applied and both above and left neighbouring samples are available;
S[W′/8, −1], S[3*W′/8, −1], S[5*W′/8, −1], S[7*W′/8, −1] when LM_A mode is applied or only the above neighbouring samples are available;
S[−1, H′/8], S[−1, 3*H′/8], S[−1, 5*H′/8], S[−1, 7*H′/8] when LM_L mode is applied or only the left neighbouring samples are available;

The four neighbouring luma samples at the selected positions are down-sampled and compared four times to find two larger values: x⁰_{A} and x¹_{A}, and two smaller values: x⁰_{B} and x¹_{B}. Their corresponding chroma sample values are denoted as y⁰_{A}, y¹_{A}, y⁰_{B} and y¹_{B}. Then x_{A}, x_{B}, y_{A} and y_{B} are derived as:

$${X}_{a} = ( {x}_{A}^{0} + {x}_{A}^{1} + 1 ) >> 1 ; {X}_{b} = ( {x}_{B}^{0} + {x}_{B}^{1} + 1 ) >> 1 ; \qquad ( 2 )$$

$${Y}_{a} = ( {y}_{A}^{0} + {y}_{A}^{1} + 1 ) >> 1 ; {Y}_{b} = ( {y}_{B}^{0} + {y}_{B}^{1} + 1 ) >> 1$$

Finally, the linear model parameters α and β are obtained according to the following equations.

$$α = \frac{{Y}_{a} - {Y}_{b}}{{X}_{a} - {X}_{b}} \qquad ( 3 )$$

$$β = {Y}_{b} - α \cdot {X}_{b} \qquad ( 4 )$$

The division operation to calculate parameter α is implemented with a look-up table. To reduce the memory required for storing the table, the diff value (difference between maximum and minimum values) and the parameter α are expressed by an exponential notation. For example, diff is approximated with a 4-bit significant part and an exponent. Consequently, the table for 1/diff is reduced into 16 elements for 16 values of the significand as follows:

$$DivTable [ ] = \{ 0 , 7 , 6 , 5 , 5 , 4 , 4 , 3 , 3 , 2 , 2 , 1 , 1 , 1 , 1 , 0 \} \qquad ( 5 )$$

This would have a benefit of both reducing the complexity of the calculation as well as the memory size required for storing the needed tables. Besides the above template and left template can be used to calculate the linear model coefficients together, they also can be used alternatively in the other 2 LM modes, called LM_A, and LM_L modes.

In LM_A mode, only the above template are used to calculate the linear model coefficients. To get more samples, the above template are extended to (W+H) samples. In LM_L mode, only left template are used to calculate the linear model coefficients. To get more samples, the left template are extended to (H+W) samples.

In LM_LA mode, left and above templates are used to calculate the linear model coefficients. To match the chroma sample locations for 4:2:0 video sequences, two types of downsampling filter are applied to luma samples to achieve 2 to 1 downsampling ratio in both horizontal and vertical directions. The selection of downsampling filter is specified by a SPS level flag. The two downsmapling filters are as follows, which are corresponding to “type-0” and “type-2” content, respectively.

$$( 6 )$$

$${Rec}_{L}^{′} ( i , j ) = [ \begin{matrix}{rec}_{L} ( 2 i - 1 , 2 j - 1 ) + 2 \cdot {rec}_{L} ( 2 i - 1 , 2 j - 1 ) + {rec}_{L} ( 2 i + 1 , 2 j - 1 ) + \\ {rec}_{L} ( 2 i - 1 , 2 j ) + 2 \cdot {rec}_{L} ( 2 i , 2 j ) + {rec}_{L} ( 2 i + 1 , 2 j ) + 4\end{matrix} ] >> 3$$

$$( 7 )$$

$${rec}_{L}^{′} ( i , j ) = [ \begin{matrix}{rec}_{L} ( 2 i , 2 j - 1 ) + {rec}_{L} ( 2 i - 1 , 2 j ) + 4 \cdot {rec}_{L} ( 2 i , 2 j ) + \\ {rec}_{L} ( 2 i + 1 , 2 j ) + {rec}_{L} ( 2 i , 2 j + 1 ) + 4\end{matrix} ] >> 3$$

Note that only one luma line (general line buffer in intra prediction) is used to make the downsampled luma samples when the upper reference line is at the CTU boundary. This parameter computation is performed as part of the decoding process, and is not just as an encoder search operation. As a result, no syntax is used to convey the a and B values to the decoder.

For chroma intra mode coding, a total of 8 intra modes are allowed for chroma intra mode coding. Those modes include five traditional intra modes and three cross-component linear model modes (LM_LA, LM_A, and LM_L). Chroma mode signalling and derivation process are shown in Table 1. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the center position of the current chroma block is directly inherited.

TABLE 1
Derivation of chroma prediction mode
from luma mode when cclm_is enabled

| | Corresponding luma intra prediction mode | | | | |
|---|---|---|---|---|---|
| Chroma | | | | | X |
| prediction mode | 0 | 50 | 18 | 1 | (0 <= X <= 66 ) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

A single binarization table is used regardless of the value of sps_cclm_enabled_flag as shown in Table 2.

TABLE 2
Unified binarization table for chroma prediction mode

| Value of intra_chroma pred_mode | Bin string |
|---|---|
| 4 | 00 |
| 0 | 0100 |
| 1 | 0101 |
| 2 | 0110 |
| 3 | 0111 |
| 5 | 10 |
| 6 | 110 |
| 7 | 111 |

In Table 2, the first bin indicates whether it is regular (0) or CCLM modes (1). If it is CCLM mode, then the next bin indicates whether it is LM_LA (0) or not. If it is not LM_LA, next 1 bin indicates whether it is LM_L (0) or LM_A (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bins in Table 2 are context coded with its own context model, and the rest bins are bypass coded.

In addition, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node are allowed to use CCLM in the following way:
If the 32×32 chroma node is not split or partitioned QT split, all chroma CUs in the 32×32 node can use CCLM
If the 32×32 chroma node is partitioned with Horizontal BT, and the 32×16 child node does not split or uses Vertical BT split, all chroma CUs in the 32×16 chroma node can use CCLM.
In all the other luma and chroma coding tree split conditions, CCLM is not allowed for chroma CU.
   b. Multi-Model CCLM (MMLM)

Multiple model CCLM mode (MMLM) uses two models for predicting the chroma samples from the luma samples for the whole CU. Similar to CCLM, three multiple model CCLM modes (MMLM_LA, MMLM_A, and MMLM_L) are used to indicate if both above and left neighboring samples, only above neighboring samples, or only left neighboring samples are used in model parameters derivation.

In MMLM, neighbouring luma samples and neighbouring chroma samples of the current block are classified into two groups, each group is used as a training set to derive a linear model (i.e., a particular α and β are derived for a particular group). Furthermore, the samples of the current luma block are also classified based on the same rule for the classification of neighbouring luma samples.

Threshold (classification threshold) is calculated as the average value of the neighbouring reconstructed luma samples. A neighbouring sample at [x,y] with Rec′_{L}[x,y]<=Threshold is classified into group 1; while a neighbouring sample at [x,y] with Rec′_{L}[x,y]>Threshold is classified into group 2. Thus, the multi-model CCLM prediction for the chroma samples is:

$$P r e {d}_{c} [ x , y ] = {α}_{1} \times {Rec}_{L}^{′} [ x , y ] + {β}_{1} if {Rec}_{L}^{′} [ x , y ] \leq Threshold$$

$$Pre {d}_{c} [ x , y ] = {α}_{2} \times {Rec}_{L}^{′} [ x , y ] + {β}_{2} if {Rec}_{L}^{′} [ x , y ] > Threshold$$

c. Convolutional Cross-Component Model (CCCM)

In some embodiments, a convolutional cross-component model (CCCM) is applied to improve the cross-component prediction performance. For some embodiment, the convolutional model has 7-tap filter having a 5-tap plus sign shape spatial component, a non-linear term and a bias term. The input to the spatial 5-tap component of the filter consists of a center (C) luma sample which is collocated with the chroma sample to be predicted and its above/north (N), below/south(S), left/west (W) and right/east (E) neighbors. The nonlinear term (denoted as P) is represented as power of two of the center luma sample C and scaled to the sample value range of the content:

$$P = ( C * C + midVal ) >> bitDepth$$

That is, for 10-bit content it is calculated as:

$$P = ( C * C + 512 ) >> 10$$

The bias term (denoted as B) represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples. The filter coefficients are calculated by minimising MSE between predicted and reconstructed chroma samples in the reference area. The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

CCCM mode with 3×2 filter for non-downsampled luma samples may be used. The filter has 6-tap spatial terms, four nonlinear terms and a bias term as shown in the following:

$$C = {\sum }_{i = 0}^{5} {α}_{i} \cdot ( {L}_{i} - offsetLuma ) + {\sum }_{i = 6}^{9} {α}_{i} \cdot ( ( {( {L}_{i - 4} - offsetLuma )}^{2} + β ) >> bitDepth + {α}_{10} \cdot β + offsetChroma$$

The 6-tap spatial terms correspond to 6 neighboring luma samples (i.e., L0, L1, . . . , L5) around one chroma sample (i.e., C) to be predicted, the four non-linear terms are derived from the samples L0, L1, L2, and L3.

d. Gradient Linear Model (GLM)

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

For signaling, when the CCLM mode is enabled to the current CU, two flags are signaled separately for Cb and Cr components to indicate whether GLM is enabled to each component; if the GLM is enabled for one component, one syntax element is further signaled to select one of 16 gradient filters for the gradient calculation. The GLM can be combined with the existing CCLM by signaling one extra flag in bitstream. When such combination is applied, the filter coefficients that are used to derive the input luma samples of the linear model is calculated as the combination of the selected gradient filter of the GLM and the down-sampling filter of the CCLM.

e. Cross-Component Residual Model (CCRM)

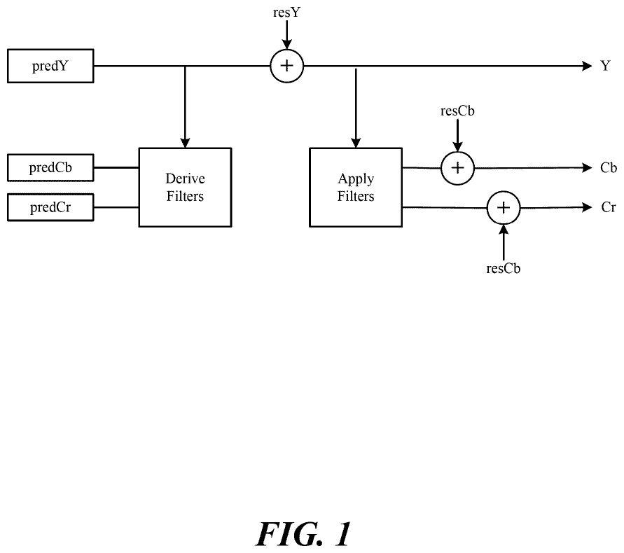

Cross-component residual model (CCRM) may be applied to predict chroma samples from reconstructed luma samples when the block uses inter prediction or intra block copy (IBC). FIG. 1 illustrates reconstruction of component samples using cross-component residual model (CCRM). The figure illustrates the decoder side of the method. The cross-component filters are derived using the prediction signals of luma and chroma. The derived filters are applied to the reconstructed luma signal producing the final chroma predictions.

The term “LM” in this disclosure can be viewed as one kind of CCLM/MMLM modes or any other extension/variation of CCLM (e.g. the proposed CCLM extension/variation in this invention). One variation is MMLM which uses thresholds to decide different models for different samples in the current chroma component. Another variation is that for Cb (or Cr), deriving model parameters from multiple collocated luma blocks. The following show more possible variations. The variations of CCLM here mean that some optional modes can be selected when the block indication refers to using one of cross-component modes (e.g. CCLM_LT, MMLM_LT, CCLM_L, CCLM_T, MMLM_L, MMLM_T, and/or an intra prediction mode, which is not one of traditional DC, planar, and angular modes) for the current block. The following shows an example of being convolutional cross-component mode (CCCM) as an optional mode. When this optional mode is applied to the current block, cross-component information with a model, including non-linear term, is used to generate the chroma prediction. The optional mode may follow the template selection of CCLM, so CCCM family includes CCCM_LT CCCM_L, and/or CCCM_T. The proposed methods (for CCLM) in this disclosure can be used for any other cross-component modes.

### III. Refining Cross-Component Models

a. Refinement by Using Guided Parameter Set

The guided parameter set is used to refine the derived model parameters by a specified CCLM mode. In some embodiments, the guided parameter set is explicitly signaled in the bitstream, after deriving the model parameters, the guided parameter set is added to the derived model parameters as the final model parameters. The guided parameter set contains at least one of a differential scaling parameter (dA), a differential offset parameter (dB), and a differential shift parameter (dS). For example, the guided parameter set rewrites equation (1) as pred_{C}(i, j)=((a′·rec_{L}′(i, j))>>s)+β, and if dA is signaled, the final prediction is pred_{C}(i, j)=(((α′+dA). rec_{L}′(i,j))>>s)+β. Similarly, if dB is signalled, then the final prediction is pred_{C}(i, j)=((α′·rec_{L}′(i,j))>s)+(β+dB). If dS is signalled, then the final prediction is pred_{C}(i, j)=((α′·rec_{L}′(i,j))>>(s+dS))+β. If dA and dB are signalled, then the final prediction is pred_{C}(i,j)=(((α′+dA)·rec_{L}′(i,j))>s)+(β+dB).

The guided parameter set may be signaled per color component. For example, one guided parameter set is signaled for Cb component, and another guided parameter set is signaled for Cr component. Or one guided parameter set is signaled and shared among color components. The signaled dA and dB could be a positive or negative value. When signaling dA, one bin is signaled to indicate the sign of dA. Similarly, when signaling dB, one bin is signaled to indicate the sign of dB.

b. Refinement by Using Inherited Neighboring Model Parameters

In some embodiments, the final scaling parameter of the current block is inherited from the neighboring blocks and further refined by dA (e.g., dA derivation or signaling can be similar or the same as refinement by using guided parameter set described in Section III.a). Once the final scaling parameter is determined, the offset parameter (e.g., β in CCLM) is derived based on the inherited scaling parameter and the average value of neighboring luma and chroma samples of the current block. For example, if the final scaling parameter is inherited from a selected neighboring block, and the inherited scaling parameter is α′ₙₑᵢ, then the final scaling parameter is (α′ₙₑᵢ+dA).

In some embodiments, the final scaling parameter is inherited from a historical list and further refined by dA. For example, the historical list records the most recent j entries of final scaling parameters from previous CCLM-coded blocks. Then, the final scaling parameter is inherited from one selected entry of the historical list, α′ₗᵢₛₜ, and the final scaling parameter is (α′ₗᵢₛₜ+dA). In some embodiments, the final scaling parameter is inherited from a historical list or the neighboring blocks, but only the MSB part of the inherited scaling parameter is taken, and the LSB of the final scaling parameter is from dA. In some embodiments, the final scaling parameter is inherited from a historical list or the neighboring blocks and does not further refine by dA.

In some embodiments, after inheriting model parameters, the offset may be further refined by dB. For example, if the final offset parameter is inherited from a selected neighboring block, and the inherited offset parameter is β′ₙₑᵢ, then the final scaling parameter is (β′ₙₑᵢ+dB). For still another embodiment, the final offset parameter is inherited from a historical list and further refined by dB. For example, the historical list records the most recent j entries of final scaling parameters from previous CCLM-coded blocks. Then, the final scaling parameter is inherited from one selected entry of the historical list, B′ₗᵢₛₜ, and the final scaling parameter is (B′ₗᵢₛₜ+dB).

### V. Inheriting Cross-Component Models

a. Model Information being Inherited

In some embodiments, if the inherited neighbor block is coded with CCCM, the filter coefficients (cᵢ) are inherited. The offset parameter (e.g., c₆×B or c₆ in CCCM) could be re-derived based on the inherited parameter and the average value of neighboring corresponding position luma and chroma samples of the current block. In some embodiments, only partial filter coefficients are inherited (e.g., only n out of 6 filter coefficients are inherited, where 1≤n<6), the rest filter coefficients are further re-derived using the neighboring luma and chroma samples of the current block.

In some embodiments, if the inherited candidate applies GLM gradient pattern to its luma reconstruction samples, the current block shall also inherit the GLM gradient pattern of the candidate and apply to the current luma reconstruction samples.

In some embodiments, if the inherited neighbor block is coded with multiple cross-component models (e.g., MMLM, or CCCM with multi-model), the classification threshold is also inherited to classify the neighboring samples of the current block into multiple groups, and the inherited multiple cross-component model parameters are further assigned to each group. In some embodiments, the classification threshold is the average value of the neighboring reconstructed luma samples, and the inherited multiple cross-component model parameters are further assigned to each group. Similarly, once the final scaling parameter of each group is determined, the offset parameter of each group is re-derived based on the inherited scaling parameter and the average value of neighboring luma and chroma samples of each group of the current block. For example, if CCCM with multi-model is used, once the final coefficient parameter of each group is determined (e.g., c₀ to C₅ except c₆ in CCCM), the offset parameter (e.g., c₆×B or c₆ in CCCM) of each group is re-derived based on the inherited coefficient parameter and the neighboring luma and chroma samples of each group of the current block.

In some embodiments, inheriting model parameters may depend on color component. For example, Cb and Cr components may inherit model parameters or model derivation method from the same candidate or different candidates. For another example, only one of the color components inherit model parameters, and the other color components use derived model parameters based on the inherited model derivation method (e.g., if the inherited candidate is coded by MMLM or CCCM, the current block also derive model parameters based on MMLM or CCCM using the current neighboring reconstruction samples). For another example, only one of color components inherit model parameters, and the other color component derives its model parameters using the current neighboring reconstruction samples.

In some embodiments, after decoding a block, a cross-component model of the current block is derived and stored for later reconstruction process of (subsequent) neighboring blocks that use inherited model parameters.

In some embodiments, even if the current block is coded by inter prediction, the cross-component model parameters of the current block may be derived by using the current luma and chroma reconstruction or prediction samples. Later, if another block is predicted by using inheriting neighbors model parameters, it may inherit the model parameters from the (inter-predicted) current block.

In some embodiments, even if the current block is coded by cross-component prediction, the cross-component model parameters of the current block may be re-derived by using the current luma and chroma reconstruction or prediction samples.

In some embodiments, the stored cross-component model may be CCCM, LM_LA (single model LM using both above and left neighboring samples to derive model), or MMLM_LT (multi-model LM using both above and left neighboring samples to derive model).

b. Inheriting Temporal Neighboring Model Parameters

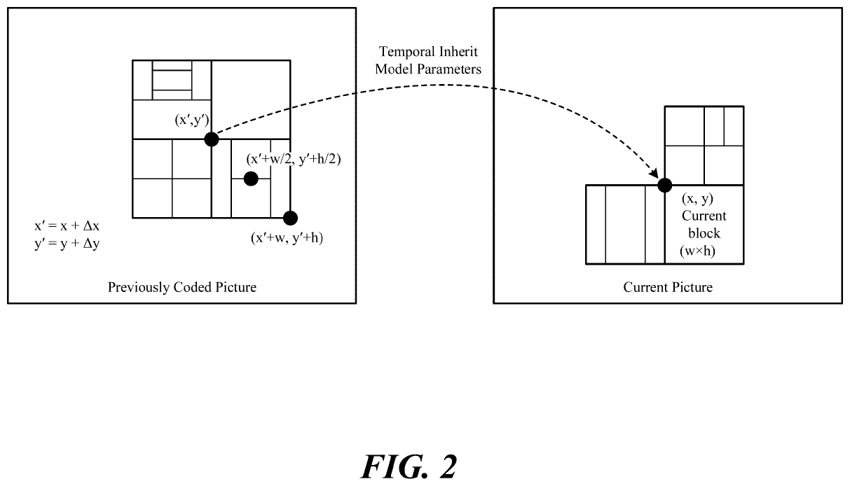

In some embodiments, if the current slice/picture is a non-intra slice/picture, the inherited model parameters could from the block in the previous coded slices/pictures. FIG. 2 conceptually illustrates inheriting temporal neighboring model parameters. As illustrated the current block position is at (x, y) and the block size is w×h. The inherited model parameters could from the block at position (x′, y′), (x′, y′+h/2), (x′+w/2, y′), (x′+w/2, y′+h/2), (x′+w, y′), (x′, y′+h), or (x′+w, y′+h) of the previous coded slices/picture, where x′=x+Δx and y′=y+Δy. In some embodiments, if the prediction mode of the current block is intra, Δx and Δy are set to 0. If the prediction mode of the current block is inter, Δx and Δy are set to the horizontal and vertical motion vector of the current block. In some embodiments, if the current block is inter bi-prediction, Δx and Δy are set to the horizontal and vertical motion vector in reference picture list 0. In still another embodiment, if the current block is inter bi-prediction, Δx and Δy are set to the horizontal and vertical motion vector in reference picture list 1.

c. Remove or Modify Similar Neighboring Model Parameters

In some embodiments, when inheriting cross-component model parameters from other blocks, the video coder may further check the similarity between the inherited model and the existing models in a candidate list or those model candidates derived by the neighboring reconstruction samples of the current block (e.g., models derived by CCLM, MMLM, or CCCM using the neighboring reconstruction samples of the current block). If the model of a candidate parameter is similar to the existing models, the model would not be included into the candidate list. In some embodiments, the video coder may compare the similarity of (α×lumaAvg+β) or a among existing candidates to decide whether to include the model of a candidate or not.

For example, if the (α×lumaAvg+β) or a of the candidate is the same as one of the existing candidates, the model of the candidate is not included. For another example, if the difference of (α×lumaAvg+β) or a between the candidate and one of existing candidates is less than a threshold, the model of the candidate is not included. Besides, the threshold may be adaptive based on coding information (e.g., the current block size or area). For another example, when comparing the two CCCM models (e.g., a candidate model and a pre-existing model), the video coder may compute their similarity by checking the value of (c₀C+c₁N+c₂S+c₃E+c₄W+c₅P+c₆B) to decide whether to include the model of a candidate or not.

In some embodiments, if a candidate position point to a CU which is the same one of the existing candidates, the model of the candidate parameter is not included. In some embodiments, if the model of a candidate is similar to one of existing candidate models, it may adjust the inherited model parameters to make the inherited model be different from the existing candidate models. For example, if the inherited scaling parameter is similar to one of existing candidate models, the inherited scaling parameter may add a predefined offset (e.g., 1>>S or −(1>>S), where S is the shift parameter) to make the inherited parameter be different from the existing candidate models.

d. Reorder Candidates in the List

In some embodiments, the candidates in the list may be reordered to reduce the syntax overhead when signaling the selected candidate index. The reordering rules could depend on the coding information of neighboring blocks or the model error. For example, if neighboring above or left blocks are coded by MMLM, the MMLM candidates in the list may be moved to the head of the current list. Similarly, if neighboring above or left blocks are coded by single model LM or CCCM, the single model LM or CCCM candidates in the list may be moved to the head of the current list. Similarly, if GLM is used by neighboring above or left blocks, the GLM related candidates in the list could be moved to the head of the current list.

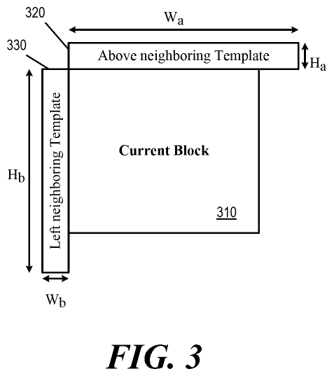

In some embodiments, the reordering rule is based on the model error by applying the candidate model to the neighboring templates of the current block, and then compare the error with the reconstruction samples of the neighboring template. FIG. 3 conceptually illustrates neighboring templates of the current block. As illustrated, the size of above neighboring template 320 of the current block 310 is wₐ×hₐ, and the size of left neighboring template 330 of the current block 310 is w_{b}×h_{b}. Suppose K models are in the current candidate list, and αₖ and βₖ are the final scale and offset parameters after inheriting the candidate k. The model error of candidate k by the above neighboring template is:

$${e}_{a}^{k} = {\sum }_{i , j} \vert ( {α}_{k} \times r e c {L}_{a}^{′ ( i , j )} + {β}_{k} ) - r e c {C}_{a}^{( i , j )} \vert$$

where,

$$r e c {L}_{a}^{′ ( i , j )} and {recC}_{a}^{( i ,}$$

are the reconstruction samples of luma (e.g., after downsampling process or after applying GLM pattern) and reconstruction samples of chroma at position (i, j) in the above template, and 0≤i<wₐ and 0≤j<hₐ. Similarly, the model error of candidate k by the left neighboring template is:

$${e}_{b}^{k} = {\sum }_{m , n} \vert ( {α}_{k} \times r e c {L}_{b}^{′ ( m , n )} + {β}_{k} ) - r e c {C}_{b}^{( m , n )} \vert$$

where

$${recL}_{b}^{′ ( m , n )} and {recC}_{b}^{( m , n )}$$

are the reconstruction samples of luma (e.g., after applying downsampling process or GLM pattern) and reconstruction samples of chroma at position (m, n) in the left template, and 0≤m<w_{b} and 0≤n<h_{b}. Then the model error of candidate k is:

$${e}^{k} = {e}_{a}^{k} + {e}_{b}^{k}$$

After calculating the model error among all candidates, it could get a model error list

$$E = \{ {e}^{0} , {e}^{1} , {e}^{2} , … , {e}^{k} , … , {e}^{K} \} .$$

Then, it could reorder the candidate index in the inherit candidate list by sorting the model error list in ascending order.

In some embodiments, if the candidate k uses CCCM prediction, the

$${e}_{a}^{k} and {e}_{b}^{k}$$

are defined as

$${e}_{a}^{k} = {\sum }_{i , j} \vert ( c {0}_{k} \times r e c {L}_{a}^{′ ( i , j )} + c {1}_{k} \times r e c {L}_{a}^{′ ( i , j - 1 )} + c {2}_{k} \times r e c {L}_{a}^{′ ( i , j + 1 )} + c {3}_{k} \times r e c {L}_{a}^{′ ( i - 1 , j )} + c {4}_{k} \times r e c {L}_{a}^{′ ( i + 1 , j )} + c {5}_{k} \times P + c {6}_{k} \times B ) - r e c {C}_{a}^{( i , j )} \vert$$

$${e}_{b}^{k} = {\sum }_{i , j} \vert ( c {0}_{k} \times r e c {L}_{b}^{′ ( i , j )} + c {1}_{k} \times r e c {L}_{b}^{′ ( i , j - 1 )} + c {2}_{k} \times r e c {L}_{b}^{′ ( i , j + 1 )} + c {3}_{k} \times r e c {L}_{b}^{′ ( i - 1 , j )} + c {4}_{k} \times r e c {L}_{b}^{′ ( i + 1 , j )} + c {5}_{k} \times P + c {6}_{k} \times B ) - r e c {C}_{b}^{( i , j )} \vert$$

where c0ₖ, c1ₖ, c2ₖ, c3ₖ, C4ₖ, C5ₖ, and c6ₖ are the final filtering coefficients after inheriting the candidate k. P and B are the nonlinear term and bias term.

In some embodiments, if the above neighboring template is not available, then

$${e}^{k} = {e}_{b}^{k} .$$

Similarly, if the left neighboring template is not available, then

$${e}^{k} = {e}_{a}^{k} .$$

If both templates are not available, the candidate index reordering method using model error is not applied.

In some embodiments, not all positions inside the above and left neighboring template are used in calculating model error. The video coder may choose partial positions inside the above and left neighboring template to calculate model error. For example, it may define a first start position and a first subsampling interval depends on the width of the current block to partially select positions inside the above neighboring template. Similarly, it could define a second start position and a second subsampling interval depends on the height of the current block to partially select positions inside the left neighboring template. For another example, hₐ or h_{b} could be a constant value (e.g., hₐ or h_{b} could be 1, 2, 3, 4, 5, or 6). For another example, hₐ or h_{b} could be depends on block size. If the current block size is greater than or equal to a threshold, hₐ or h_{b} is equal to a first value. Otherwise, hₐ or h_{b} is equal to a second value.

e. Inherit Candidates from the Candidates in the Candidate List of Neighbors

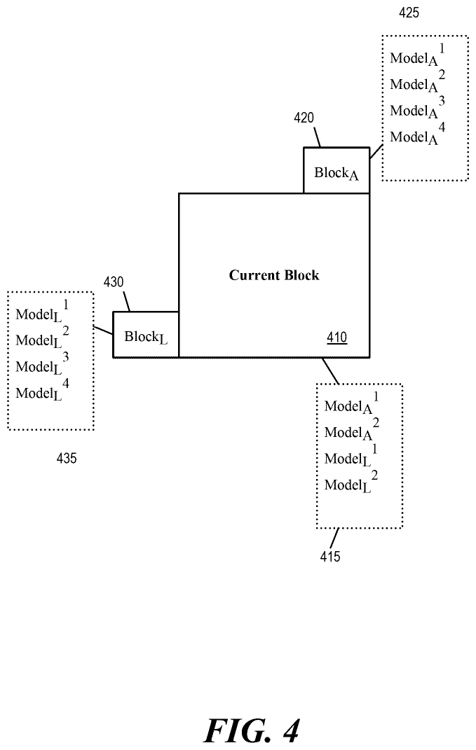

In some embodiments, the current block may inherit the first k candidates in the inherit candidate list of the neighboring blocks. FIG. 4 conceptually illustrates lists of candidates the current block and neighboring blocks. As illustrated, the current block 410 has an above neighboring block 420 and a left neighboring block 430. The above neighboring block 420 has a list of candidates 425 that includes various models (shown as Model_{A}¹, Model_{A}², Model_{A}³, Model_{A}⁴). The left neighboring block 430 has its own list of candidates 425 that includes various models (shown as Model_{L}¹, Model_{L}², Model_{L}³, Model_{L}⁴). The current block 410 may inherit the first two candidates (Model_{A}¹, Model_{A}²) from the above neighboring block and the first two candidates (Model_{L}¹, Model_{L}²) from the left neighboring block, as part of its own list of candidates 415.

In some embodiments, after adding the neighboring spatial candidates and non-adjacent spatial candidates, if the current inherit candidate list is not full, the candidates in the candidate list of neighboring blocks are included into the current inherit candidate list. In some other embodiments, when adding candidates to the candidate list of neighboring blocks, the candidates in the candidate list of left neighboring blocks are included before the candidates in the candidate list of above neighboring blocks. In some embodiments, when adding candidates in the candidate list of neighboring blocks, the candidates in the candidate list of above neighboring blocks are included before the candidates in the candidate list of left neighboring blocks.

f. Signaling the Inherited Candidate Index

In some embodiments, an on/off flag is signaled to indicate if the current block inherits a cross-component model parameters from neighboring blocks or not. The flag can be signaled per CU/CB, per PU, per TU/TB, or per color component, or per chroma color component. A high-level syntax could be signaled in SPS, PPS, PH or SH to indicate if to indicate if inheriting cross-component model parameters from neighboring blocks is allowed for the current sequence, picture, or slice. If the current block inherits the cross-component model parameters from neighboring blocks, an index that corresponds to the inherited candidate is signaled. The index may be signaled (e.g., signaled using truncate unary code, Exp-Golomb code, or fix length code) and shared among both the current Cb and Cr blocks. For another example, the index may be signaled per color component. For example, one inherited index is signaled for Cb component, and another inherited index is signaled for Cr component. For another example, it may use chroma intra prediction syntax (e.g., IntraPredModeC[xCb][yCb]) to store the inherited index.

In some embodiments, if the current block inherits the cross-component model parameters from neighboring blocks, the current chroma intra prediction mode (e.g., IntraPredModeC[xCb][yCb] as defined in VVC standard) is temporally set to a cross-component mode (e.g., CCLM_LT) at the bitstream syntax parsing stage. Later, at the prediction stage or reconstruction stage, the candidate list is derived, and the inherited candidate model is identified by the inherit candidate index from the candidate list. After obtaining the inherited model, the coding information of the current block is updated according to the inherit candidate model. The coding information of the current block includes but not limited to the prediction mode (e.g., CCLM_LT or MMLM_LT), related sub-mode flags (e.g., CCCM mode flag), prediction pattern (e.g., GLM pattern index), and the current model parameters. Then, the prediction of the current block is generated according to the updated coding information.

### VI. Fusion of Multiple Cross-Component Models

In some embodiments, the final prediction of the current block may be a combination of multiple cross-component models, or fusion multiple selected cross-component models with the prediction by non-cross-component coding tools (e.g., intra angular prediction modes, intra planar/DC modes, or inter prediction modes).

a. Fusion of Multiple Models from the List of Candidate Models

In some embodiments, if the current candidate list size is N, the video coder may select k candidates from the total N candidates (where k≤N). Then, k predictions are respectively generated by applying the cross-component model of the selected k candidates using the corresponding luma reconstruction samples. The final prediction of the current block is the combination results of these k predictions. For example, if two candidate predictions (denoted as p_{cand1} and p_{cand2}) are combined, the final prediction at (x, y) position of the current block is p_{final}(x, y)=(1−a)×p_{cand1}(x, y)+α×p_{cand2}(x, y), where a is a weighting factor. The weighting factor α may be predefined or implicitly derived by neighboring template cost. For example, in some embodiments, the template cost of two candidates are e^{cand1} and e^{cand2}, and α is e^{cand1}/(e^{cand1}+e^{cand2}), with the template cost defined according to Section V.d regarding “reordering of candidates in the list”.

In some embodiments, the video coder may combine multiple cross-component models into one final cross-component model. For example, the video coder may select two models from two candidates in the list and use the selected two models to implement a multi-model cross-component prediction mode. The selected candidates may be CCLM/MMLM/GLM/CCCM coded candidates. The multi-model classification threshold (described in Section II.b above) may be the average of the offset parameters (e.g., offset/B in CCLM, or c₆×B or c₆ in CCCM) of the two selected models. In some embodiments in which two candidate models are combined, the selected models are the first two candidates in the list.

More generally, if the current candidate list size is N, the video coder may select k candidates from the total N candidates (where k≤N) to be combined into one final cross-component model. In some embodiments, such combination is by weighted-averaging the corresponding model parameters of the k candidates. For example, if a cross-component model has M parameters, the j-th parameter of the final cross-component model are the weighted-averaging of the j-th parameter of the k selected candidates where j is 1 . . . M. Then, the final prediction is by applying the final cross-component model to the corresponding luma reconstruction samples.

For example, if two candidate models are

$$\{ {c}_{0}^{0} , {c}_{1}^{0} , … , {c}_{M - 1}^{0} \} and \{ {c}_{0}^{1} , {c}_{1}^{1} , … , {c}_{M - 1}^{1} \} ,$$

then the final cross-component model is

$$\{ ( 1 - α ) \times {c}_{0}^{0} + α \times {c}_{0}^{1} , ( 1 - α ) \times {c}_{1}^{0} + α \times {c}_{1}^{1} , … , ( 1 - α ) \times {c}_{M - 1}^{0} + α \times {c}_{M - 1}^{1} \} ,$$

where α is a weighting factor, which may be predefined or implicitly derived by neighboring template cost, and

$${c}_{x}^{y}$$

is the x-th parameter of the y-th candidate. The determination of such neighboring template cost is described in Section V.d above “Reordering the candidate in the list”, where the corresponding template cost of two candidates are e^{cand1} and e^{cand2}, then α is e^{cand1}/(e^{cand1}+e^{cand2}).

For another example, the video coder may combine two candidate models, with one candidate model from a spatial adjacent neighboring candidate and another candidate model from a non-adjacent spatial candidate or history candidate. In some embodiments, if the candidate model from the spatial adjacent neighboring candidate is not available, then the video coder may use two candidate models from the non-adjacent spatial candidates or history candidates. In some embodiments, if two candidate models are to be combined, the models from the first two candidates in the list are selected and combined. In some embodiments, if i candidate models are to be combined, the models from the first i candidates in the list are selected and combined.

In some embodiments, two cross-component models are combined into one final model by weighted-averaging of the corresponding model parameters, where one cross-component model is from an above spatial neighboring candidate and the other one cross-component model is from a left spatial neighboring candidate. The above spatial neighboring candidate is the neighboring candidate having/at the vertical position less than or equal to the top block boundary position of the current block. The left spatial neighboring candidate is the neighboring candidate having/at the horizontal position less than or equal to the left block boundary position of the current block. The weighting factor α is determined according to the horizontal and vertical spatial positions inside the current block. For example, if two candidate predictions (denoted as p_{above} and p_{left}) are combined, the final prediction at (x, y) position of the current block is p_{final}(x, y)=(1−a)×p_{above}(x, y)+α×p_{left}(x, y), where α=y/(x+y). In some embodiments, the above spatial neighboring candidate is the first candidate in the list having the vertical position less than or equal to the top block boundary position of the current block, and the left spatial neighboring candidate is the first candidate in the list having the horizontal position less than or equal to the left block boundary position of the current block.

b. Fusion of Cross-Component and Non-Cross-Component Predictions

In some embodiments, the video coder may combine the prediction by a cross-component model candidate with the prediction by a non-cross-component coding tool. For example, one cross-component model candidate is selected from list, and its prediction is denoted as p_{ccm}. Another prediction may be from chroma DM (inheriting the intra prediction mode of the luma block), chroma DIMD, or intra angular mode, and denoted as p_{non-ccm}. The final prediction at (x, y) position of the current block is p_{final}(x, y)=(1−α)×p_{ccm}(x, y)+α×p_{non-ccm}(x, y), where a is the weighting factor which may be predefined or implicitly derived by neighboring template cost.

In some embodiments, when combining predictions between cross-component and non-cross-component coding tools, the prediction by the non-cross-component coding tool (e.g., chroma DM, chroma DIMD) may be predefined or signaled. In some embodiments, prediction by non-cross-component coding tool is signaled, but the index of cross-component model candidate is predefined or determined by neighboring blocks coding mode. For example, in some embodiments, if at least one of neighboring spatial blocks is coded with CCCM mode, the first candidate with CCCM model parameters is selected. For another example, if at least one of neighboring spatial blocks is coded with GLM mode, the first candidate with GLM pattern parameters is selected. For another example, if at least one of the neighboring spatial blocks is coded with MMLM mode, the first candidate has MMLM parameters is selected.

c. Fusion of Cross-Component Model Candidates with the Prediction by the Current Cross-Component Model

In this document, a “candidate cross-component model” or “cross-component model candidate” or “inherited cross-component model” refers to a cross-component model that is inherited from a previous coded block and/or selected from a list of candidate models. On the other hand, a “current cross-component model” refers to a cross-component model that is not inherited from a previous coded block and not selected from a list of candidates, but rather derived for the current block based on the current block. For example, the current cross-component model may be derived based on predicted samples of the current block, or predicted samples or reconstructed samples of a component (e.g., luma or one of the chroma components) of the current block, or reconstructed samples of neighboring samples of the current block (e.g., in above and/or left template regions), or samples of a reference block (identified by MV or BV) of the current block.

In some embodiments, the video coder may combine the prediction by a cross-component model candidate with the prediction by the current cross-component model. For example, let the p_{ccm} denote the prediction of a cross-component model from a candidate in the list and p_{curr-ccm} denote the cross-component prediction derived using the neighboring reconstruction samples of the current block, then the final prediction at (x, y) position of the current block is p_{final}(x, y)=(1−α)×p_{ccm}(x, y)+α×p_{curr-ccm}(x, y), where a is the weighting factor which could be predefined or implicitly derived by neighboring template cost. In some embodiments, the video coder selects the first candidate in the list as the cross-component model candidate.

In some embodiments, the prediction mode or type of the current cross-component model may be predefined or signaled. Examples of the prediction mode or type of a cross-component coding tool (whether current or candidate) include CCCM_LT, LM_LT (single model LM using both top and left neighboring samples to derive model), or MMLM_LT (multi-model LM using both top and left neighboring samples to derive model).

In some embodiments, when combining a cross-component model candidate from the list with the prediction by the current cross-component model, the prediction mode of the current cross-component model (e.g., CCLM/MMLM/GLM/CCCM, or their variants) is indicated first, and a syntax for indicating whether to combine with a cross-component model candidate is indicated later. The indication of the prediction mode of the current cross-component model may be explicitly signaled or implicitly derived. For an example, the cross-component model candidate may be the first candidate in the candidate list. For another example, the cross-component model candidate may be the first candidate after reordering the candidate list. In some embodiments, the combination weight may be predefined, determined by the neighboring prediction modes, or implicitly derived by neighboring template cost (e.g., Section V.d Reorder the candidates in the list).

In some embodiments, when combining the predictions of a selected cross-component model candidate with the prediction by the current cross-component model, the syntax for determining whether to use the cross-component model candidate is indicate first, and the syntax for determining whether to combine the predictions by the current cross-component model and the selected cross-component model candidate is indicated later.

In some embodiments, when combining the prediction of the current cross-component model with the prediction of the selected candidate cross-component model, the current cross-component model is set to have the same cross-component prediction mode or type as that of the selected candidate cross-component model (e.g., both are CCLM, both are CCCM, etc.). In some embodiments, when the current cross-component model and the candidate cross-component model have the same prediction type/mode, the video coder may calculate the combined prediction by combining their respective model parameters. For example, the parameters of current cross-component model may be expressed as

$$\{ {c}_{0}^{0} , {c}_{1}^{0} , … , {c}_{M - 1}^{0} \}$$

and the parameters of the selected candidate may be expressed as

$$\{ {c}_{0}^{0} , {c}_{1}^{0} , … , {c}_{M - 1}^{0} \}$$

then the final cross-component model used to calculate the combined prediction is

$$\{ ( 1 - α ) \times {c}_{0}^{0} + α \times {c}_{0}^{1} , ( 1 - α ) \times {c}_{1}^{0} + α \times {c}_{1}^{1} , … , ( 1 - α ) \times {c}_{M - 1}^{0} + α \times {c}_{M - 1}^{1} \} ,$$

where α is a weighting factor which could be predefined, determined by the neighboring prediction modes, or implicitly derived by neighboring template cost, and

$${c}_{x}^{y}$$

are the model parameters.

In some embodiments, whether to apply the approach of combining cross-component model candidates with the prediction by the current cross-component model may depend on block size constraint. The block size constraint may be the block size is less than or equal to a threshold, or the block size is greater than or equal to a threshold. The block size may refer to the block width, block height, block width multiply block height, block width plus block height, block size aspect ratio, or their variants.

Any of the foregoing proposed methods can be implemented in encoders and/or decoders. For example, any of the proposed methods can be implemented in an inter/intra/prediction module of an encoder, and/or an inter/intra/prediction module of a decoder. Alternatively, any of the proposed methods can be implemented as a circuit coupled to the inter/intra/prediction module of the encoder and/or the inter/intra/prediction module of the decoder, so as to provide the information needed by the inter/intra/prediction module

### VII. Example Video Encoder

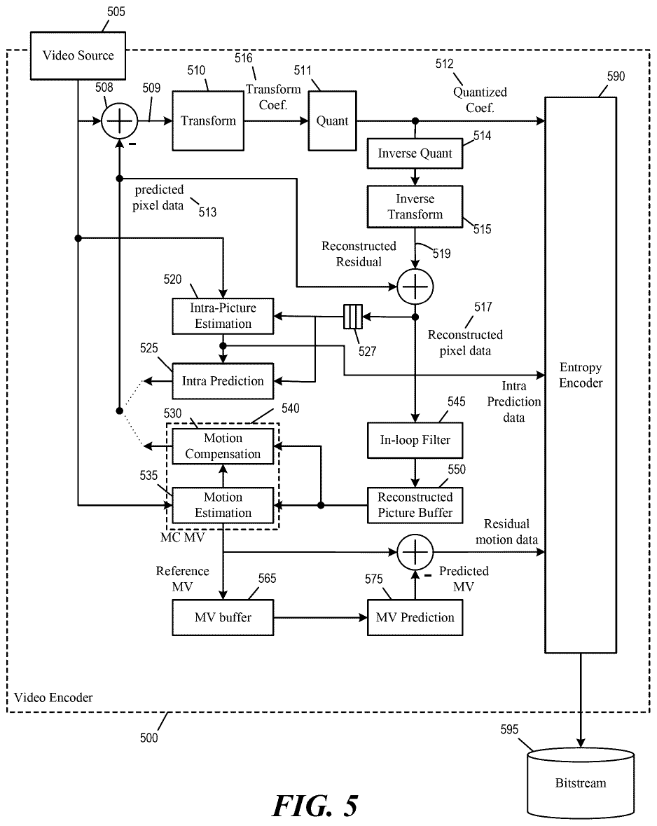

FIG. 5 illustrates an example video encoder 500 that may implement cross-component predictions. As illustrated, the video encoder 500 receives input video signal from a video source 505 and encodes the signal into bitstream 595. The video encoder 500 has several components or modules for encoding the signal from the video source 505, at least including some components selected from a transform module 510, a quantization module 511, an inverse quantization module 514, an inverse transform module 515, an intra-picture estimation module 520, an intra-prediction module 525, a motion compensation module 530, a motion estimation module 535, an in-loop filter 545, a reconstructed picture buffer 550, a MV buffer 565, and a MV prediction module 575, and an entropy encoder 590. The motion compensation module 530 and the motion estimation module 535 are part of an inter-prediction module 540.

In some embodiments, the modules 510-590 are modules of software instructions being executed by one or more processing units (e.g., a processor) of a computing device or electronic apparatus. In some embodiments, the modules 510-590 are modules of hardware circuits implemented by one or more integrated circuits (ICs) of an electronic apparatus. Though the modules 510-590 are illustrated as being separate modules, some of the modules can be combined into a single module.

The video source 505 provides a raw video signal that presents pixel data of each video frame without compression. A subtractor 508 computes the difference between the raw video pixel data of the video source 505 and the predicted pixel data 513 from the motion compensation module 530 or intra-prediction module 525 as prediction residual 509. The transform module 510 converts the difference (or the residual pixel data or residual signal 508) into transform coefficients (e.g., by performing Discrete Cosine Transform, or DCT). The quantization module 511 quantizes the transform coefficients into quantized data (or quantized coefficients) 512, which is encoded into the bitstream 595 by the entropy encoder 590.

The inverse quantization module 514 de-quantizes the quantized data (or quantized coefficients) 512 to obtain transform coefficients, and the inverse transform module 515 performs inverse transform on the transform coefficients to produce reconstructed residual 519. The reconstructed residual 519 is added with the predicted pixel data 513 to produce reconstructed pixel data 517. In some embodiments, the reconstructed pixel data 517 is temporarily stored in a line buffer 527 (or intra prediction buffer) for intra-picture prediction and spatial MV prediction. The reconstructed pixels are filtered by the in-loop filter 545 and stored in the reconstructed picture buffer 550. In some embodiments, the reconstructed picture buffer 550 is a storage external to the video encoder 500. In some embodiments, the reconstructed picture buffer 550 is a storage internal to the video encoder 500.

The intra-picture estimation module 520 performs intra-prediction based on the reconstructed pixel data 517 to produce intra prediction data. The intra-prediction data is provided to the entropy encoder 590 to be encoded into bitstream 595. The intra-prediction data is also used by the intra-prediction module 525 to produce the predicted pixel data 513.

The motion estimation module 535 performs inter-prediction by producing MVs to reference pixel data of previously decoded frames stored in the reconstructed picture buffer 550. These MVs are provided to the motion compensation module 530 to produce predicted pixel data.

Instead of encoding the complete actual MVs in the bitstream, the video encoder 500 uses MV prediction to generate predicted MVs, and the difference between the MVs used for motion compensation and the predicted MVs is encoded as residual motion data and stored in the bitstream 595.

The MV prediction module 575 generates the predicted MVs based on reference MVs that were generated for encoding previously video frames, i.e., the motion compensation MVs that were used to perform motion compensation. The MV prediction module 575 retrieves reference MVs from previous video frames from the MV buffer 565. The video encoder 500 stores the MVs generated for the current video frame in the MV buffer 565 as reference MVs for generating predicted MVs.

The MV prediction module 575 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 595 by the entropy encoder 590.

The entropy encoder 590 encodes various parameters and data into the bitstream 595 by using entropy-coding techniques such as context-adaptive binary arithmetic coding (CABAC) or Huffman encoding. The entropy encoder 590 encodes various header elements, flags, along with the quantized transform coefficients 512, and the residual motion data as syntax elements into the bitstream 595. The bitstream 595 is in turn stored in a storage device or transmitted to a decoder over a communications medium such as a network.

The in-loop filter 545 performs filtering or smoothing operations on the reconstructed pixel data 517 to reduce the artifacts of coding, particularly at boundaries of pixel blocks. In some embodiments, the filtering or smoothing operations performed by the in-loop filter 545 include deblock filter (DBF), sample adaptive offset (SAO), and/or adaptive loop filter (ALF). In some embodiments, luma mapping chroma scaling (LMCS) is performed before the loop filters.

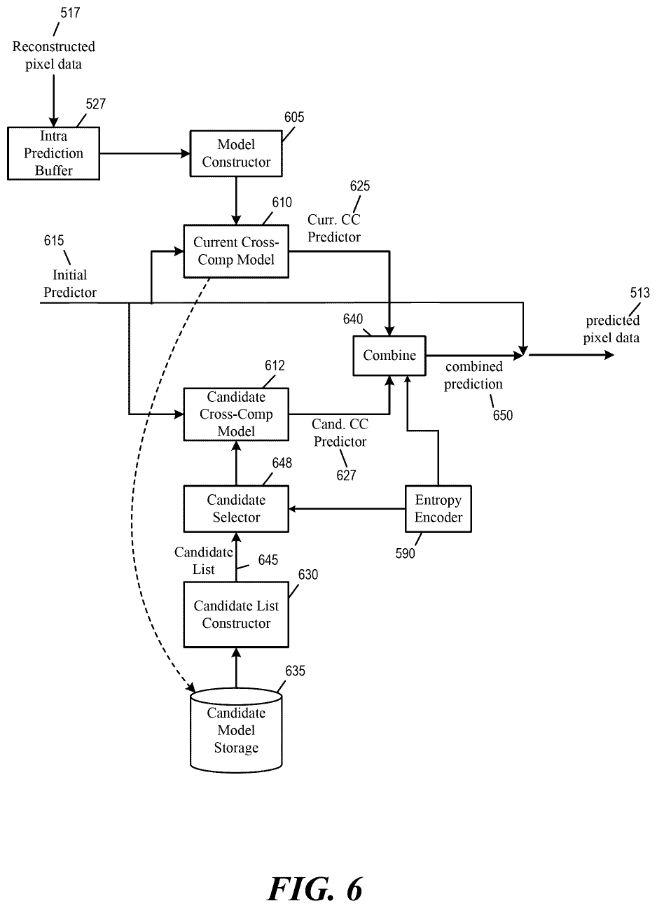

FIG. 6 illustrates portions of the video encoder 500 that implement combined cross-component predictions. The current block may be initially coded by inter-prediction, intra-prediction, or IBC prediction (motion compensation module 530 or intra prediction module 525), which generate an initial predictor 615. The initial predictor 615 may be the luma component or one of the chroma component (e.g., Cb) of the predicted or reconstructed current block.

Two cross-component models are applied to the initial predictor 615: a current cross-component model 610 is applied to the initial predictor 615 to generate a first cross-component predictor 625; and a candidate cross-component model 612 is applied to the initial predictor 615 to generate a second cross-component predictor 627. A prediction combiner 640 combines the first and second cross-component predictors 625 and 627 to produce a combined cross-component prediction 650 for the (remaining) chroma component (e.g., Cr). The samples of the initial predictor 615 and the combined cross-component prediction 650 may then be used as the predicted pixel data 513.

The current cross-component model 610 may be generated by a model constructor 605 based on samples stored in the intra-prediction buffer 527, which stores samples of the reconstructed pixel data 517 taken before the in-loop filters 545. Section II above describe several modes of cross-component models that may be used as the cross-component model 610. Once generated, (the parameters of) the current cross-component model 610 may be stored in a candidate model storage 635 to be inherited by subsequent coding blocks.

The candidate cross-component model 612 is selected from a candidate list of models 645 for the current block. The list 645 is provided by a candidate list constructor module 630, which identifies candidate models from various neighboring blocks to be added to the candidate list 645 for the current block. A candidate selector 648 selects one of the candidates from the candidate list 645 to be the candidate cross-component model 612, and that model is retrieved from the candidate model storage 635.

In some embodiments, the candidate selector 648 makes its selection based on an indication from the entropy encoder 590, which may signal into the bitstream 595 syntax elements to determine whether to use the combined prediction 650, whether to use prediction from the current cross-component model 610 or the candidate cross-component model 612, and which candidate model from the list of candidates 645 to use.

The prediction combiner 640 may generate the combined prediction 650 as a weighted average of the two predictors 625 and 627, with the weighting factors provided by the entropy encoder 590. In some embodiments, the combined prediction 650 may be generated by a combined model in which the parameters are weighted average of the two models, if the two models are of the same cross-component prediction mode/type. The entropy encoder 590 may also control the prediction combiner 640 to serve as a multiplexer between the two predictors 625 and 627, thereby disabling combining cross-component predictions.

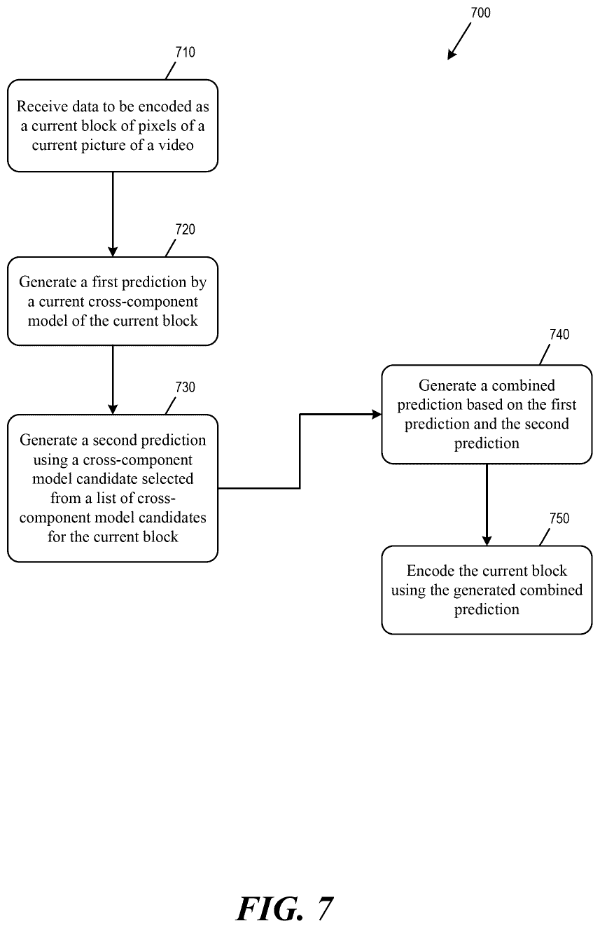

FIG. 7 conceptually illustrates a process 700 for combining cross-component predictions. In some embodiments, one or more processing units (e.g., a processor) of a computing device implementing the encoder 500 performs the process 700 by executing instructions stored in a computer readable medium. In some embodiments, an electronic apparatus implementing the encoder 500 performs the process 700.

The encoder receives (at block 710) data to be encoded as a current block of pixels in a current picture of a video.

The encoder generates (at block 720) a first prediction by a current cross-component model of the current block. The current cross-component model may be derived based on the neighboring reconstructed samples of the current block or predicted samples of the current block that are identified by the specified cross-component prediction mode. In some embodiments, the current cross-component model is set to be of a same cross-component prediction mode as that of the selected cross-component model.

The encoder generates (at block 730) a second prediction using a cross-component model candidate selected from a list of cross-component model candidates for the current block.

In some embodiments, the encoder specifies a cross-component prediction mode for the current block. The cross-component prediction mode may be CCCM, CCLM, GLM, MMLM, or any other cross-component prediction mode described in Section II above. The encoder derives the current cross-component model according to the specified cross-component prediction mode for the current block. The encoder identifies the list of cross-component model candidates for the current block, then selects the cross-component model candidate from the list of candidate cross-component models.

The encoder may determine the specified cross-component prediction mode and whether to use the combined prediction to encode the current block. In some embodiments, the determination is explicitly signaled by a first syntax element indicating the specified cross-component prediction mode and a second syntax element indicating whether to use the combined prediction to encode the current block, wherein the first syntax element is signaled or parsed before the second syntax element. In some embodiments, the encoder may determine whether to use the combined prediction to encode the current block based on a size constraint of the current block.

In some embodiments, when the combined prediction is used to encode the current block, the first candidate in the list of candidates is the selected cross-component model candidate. In some embodiments, the specified cross-component prediction mode is implicitly derived.

In some embodiments, the encoder may determine whether the cross-component model candidate is used and whether to generate the combined prediction. In some embodiments, a first syntax element indicating whether to use the selected cross-component model candidate and a second syntax element indicating whether to use the combined prediction to encode current block are explicitly signaled, with the first syntax element signaled before the second syntax element.

In some embodiments, when the selected cross-component model candidate and the current cross-component model are of the same cross-component prediction mode, the combined prediction is generated by computing weighted averages of model parameters of the selected cross-component model candidate and the current cross-component model.

The encoder generates (at block 740) a combined prediction based on the first and second predictions. The combined prediction may be a weighted sum of the first prediction and the second prediction. The weights assigned to the first and second predictions are predefined, determined by neighboring prediction modes, or implicitly derived by neighboring template cost.

The encoder encodes (at block 750) the current block by using the generated combined prediction to generate prediction residuals.

### VIII. Example Video Decoder

In some embodiments, an encoder may signal (or generate) one or more syntax element in a bitstream, such that a decoder may parse said one or more syntax element from the bitstream.

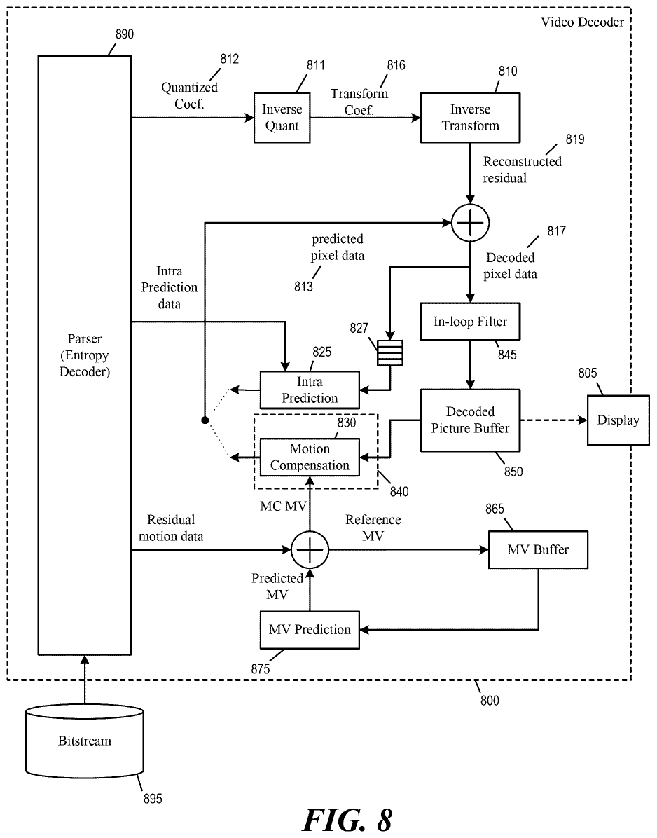

FIG. 8 illustrates an example video decoder 800 that may implement cross-component predictions. As illustrated, the video decoder 800 is an image-decoding or video-decoding circuit that receives a bitstream 895 and decodes the content of the bitstream into pixel data of video frames for display. The video decoder 800 has several components or modules for decoding the bitstream 895, including some components selected from an inverse quantization module 811, an inverse transform module 810, an intra-prediction module 825, a motion compensation module 830, an in-loop filter 845, a decoded picture buffer 850, a MV buffer 865, a MV prediction module 875, and a parser 890. The motion compensation module 830 is part of an inter-prediction module 840.

In some embodiments, the modules 810-890 are modules of software instructions being executed by one or more processing units (e.g., a processor) of a computing device. In some embodiments, the modules 810-890 are modules of hardware circuits implemented by one or more ICs of an electronic apparatus. Though the modules 810-890 are illustrated as being separate modules, some of the modules can be combined into a single module.

The parser 890 (or entropy decoder) receives the bitstream 895 and performs initial parsing according to the syntax defined by a video-coding or image-coding standard. The parsed syntax element includes various header elements, flags, as well as quantized data (or quantized coefficients) 812. The parser 890 parses out the various syntax elements by using entropy-coding techniques such as context-adaptive binary arithmetic coding (CABAC) or Huffman encoding.

The inverse quantization module 811 de-quantizes the quantized data (or quantized coefficients) 812 to obtain transform coefficients, and the inverse transform module 810 performs inverse transform on the transform coefficients 816 to produce reconstructed residual signal 819. The reconstructed residual signal 819 is added with predicted pixel data 813 from the intra-prediction module 825 or the motion compensation module 830 to produce decoded pixel data 817. The decoded pixels data are filtered by the in-loop filter 845 and stored in the decoded picture buffer 850. In some embodiments, the decoded picture buffer 850 is a storage external to the video decoder 800. In some embodiments, the decoded picture buffer 850 is a storage internal to the video decoder 800.

The intra-prediction module 825 receives intra-prediction data from bitstream 895 and according to which, produces the predicted pixel data 813 from the decoded pixel data 817 stored in the decoded picture buffer 850. In some embodiments, the decoded pixel data 817 is also stored in a line buffer 827 (or intra prediction buffer) for intra-picture prediction and spatial MV prediction.

In some embodiments, the content of the decoded picture buffer 850 is used for display. A display device 805 either retrieves the content of the decoded picture buffer 850 for display directly, or retrieves the content of the decoded picture buffer to a display buffer. In some embodiments, the display device receives pixel values from the decoded picture buffer 850 through a pixel transport.

The motion compensation module 830 produces predicted pixel data 813 from the decoded pixel data 817 stored in the decoded picture buffer 850 according to motion compensation MVs (MC MVs). These motion compensation MVs are decoded by adding the residual motion data parsed from the bitstream 895 with predicted MVs received from the MV prediction module 875.

The MV prediction module 875 generates the predicted MVs based on reference MVs that were generated for decoding previous video frames, e.g., the motion compensation MVs that were used to perform motion compensation. The MV prediction module 875 retrieves the reference MVs of previous video frames from the MV buffer 865. The video decoder 800 stores the motion compensation MVs generated for decoding the current video frame in the MV buffer 865 as reference MVs for producing predicted MVs.

The in-loop filter 845 performs filtering or smoothing operations on the decoded pixel data 817 to reduce the artifacts of coding, particularly at boundaries of pixel blocks. In some embodiments, the filtering or smoothing operations performed by the in-loop filter 845 include deblock filter (DBF), sample adaptive offset (SAO), and/or adaptive loop filter (ALF). In some embodiments, luma mapping chroma scaling (LMCS) is performed before the loop filters.

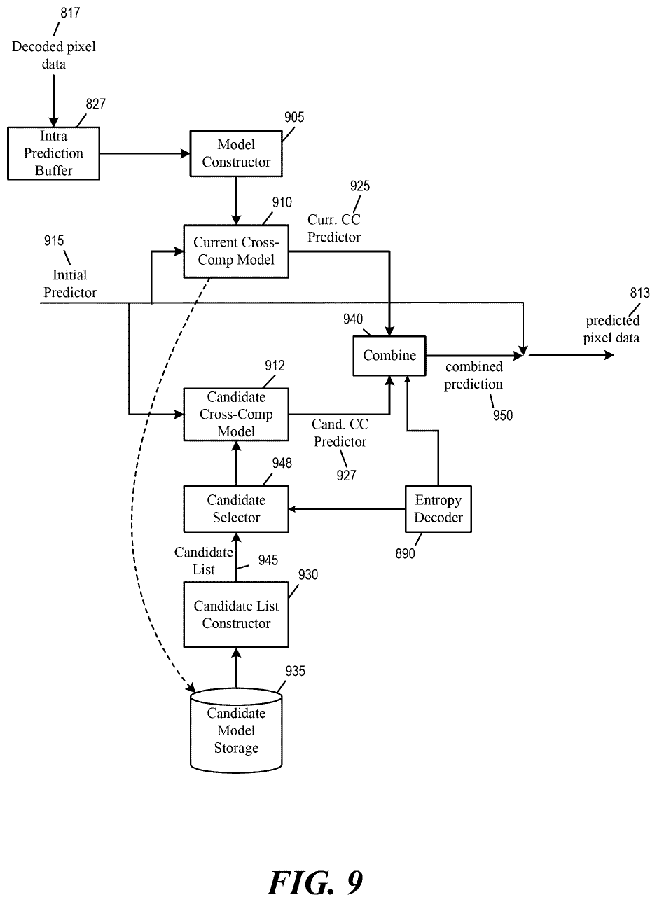

FIG. 9 illustrates portions of the video decoder 800 that implement combined cross-component predictions. The current block may be initially coded by inter-prediction, intra-prediction, or IBC prediction (motion compensation module 830 or intra prediction module 825), which generate an initial predictor 915. The initial predictor 915 may be the luma component or one of the chroma component (e.g., Cb) of the predicted or reconstructed current block.

Two cross-component models are applied to the initial predictor 915: a current cross-component model 910 is applied to the initial predictor 915 to generate a first cross-component predictor 925; and a candidate cross-component model 912 is applied to the initial predictor 915 to generate a second cross-component predictor 927. A prediction combiner 940 combines the first and second cross-component predictors 925 and 927 to produce a combined cross-component prediction 950 for the (remaining) chroma component (e.g., Cr). The samples of the initial predictor 915 and the combined cross-component prediction 950 may then be used as the predicted pixel data 813.

The current cross-component model 910 may be generated by a model constructor 905 based on samples stored in the intra-prediction buffer 827, which stores samples of the reconstructed pixel data 817 taken before the in-loop filters 845. Section II above describe several types of cross-component models that may be used as the cross-component model 910. Once generated, (the parameters of) the current cross-component model 910 may be stored in a candidate model storage 935 to be inherited by subsequent coding blocks.

The candidate cross-component model 912 is selected from a candidate list of models 945 for the current block. The list 945 is provided by a candidate list constructor module 930, which identifies candidate models from various neighboring blocks to be added to the candidate list 945 for the current block. A candidate selector 948 selects one of the candidates from the candidate list 945 to be the candidate cross-component model 912, and that model is retrieved from the candidate model storage 935.

In some embodiments, the candidate selector 948 makes its selection based on an indication from the entropy decoder 890, which may parse the bitstream 595 for syntax elements to determine whether to use the combined prediction 950, whether to use prediction from the current cross-component model 910 or the candidate cross-component model 912, and which candidate model from the list of candidates 945 to use.

In some embodiments, when the predictions generated by the current cross-component model 910 and the candidate cross-component model 912 are combined, the candidate selector 948 selects the first candidate in the candidate list 945.

The prediction combiner 940 may generate the combined prediction 950 as a weighted average of the two predictors 925 and 927, with the weighting factors provided by the entropy decoder 890. In some embodiments, the combined prediction 950 may be generated by a combined model in which the parameters are weighted average of the two models, if the two models are of the same cross-component prediction mode/type. The entropy decoder 890 may also control the prediction combiner 940 to serve as a multiplexer between the two predictors 925 and 927, thereby disabling combining cross-component predictions.

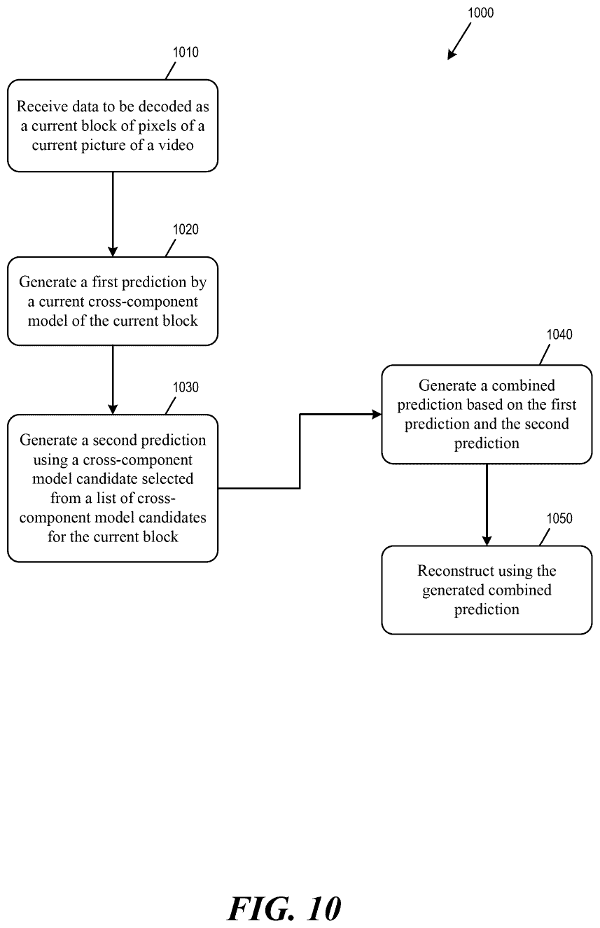

FIG. 10 conceptually illustrates a process 1000 for combining cross-component predictions. In some embodiments, one or more processing units (e.g., a processor) of a computing device implementing the decoder 800 performs the process 1000 by executing instructions stored in a computer readable medium. In some embodiments, an electronic apparatus implementing the decoder 800 performs the process 1000.

The decoder receives (at block 1010) data to be decoded as a current block of pixels in a current picture of a video. The decoder generates (at block 1020) a first prediction by a current cross-component model of the current block. The current cross-component model may be derived based on the neighboring reconstructed samples of the current block or predicted samples of the current block that are identified by the specified cross-component prediction mode. In some embodiments, the current cross-component model is set to be of a same cross-component prediction mode as that of the selected cross-component model.

The decoder generates (at block 1030) a second prediction using a cross-component model candidate selected from a list of cross-component model candidates for the current block.

In some embodiments, the decoder specifies a cross-component prediction mode for the current block. The cross-component prediction mode may be CCCM, CCLM, GLM, MMLM, or any other cross-component prediction mode described in Section II above. The decoder derives the current cross-component model according to the specified cross-component prediction mode for the current block. The decoder identifies the list of cross-component model candidates for the current block, then selects the cross-component model candidate from the list of candidate cross-component models.

The decoder may determine the specified cross-component prediction mode and whether to use the combined prediction to decode the current block. In some embodiments, the determination is explicitly signaled by a first syntax element indicating the specified cross-component prediction mode and a second syntax element indicating whether to use the combined prediction to decode the current block, wherein the first syntax element is signaled or parsed before the second syntax element. In some embodiments, the decoder may determine whether to use the combined prediction to decode the current block based on a size constraint of the current block.

In some embodiments, when the combined prediction is used to decode the current block, the first candidate in the list of candidates is the selected cross-component model candidate. In some embodiments, the specified cross-component prediction mode is implicitly derived.

In some embodiments, the decoder may determine whether the cross-component model candidate is used and whether to generate the combined prediction. In some embodiments, a first syntax element indicating whether to use the selected cross-component model candidate and a second syntax element indicating whether to use the combined prediction to decode current block are explicitly signaled, with the first syntax element signaled before the second syntax element.

In some embodiments, when the selected cross-component model candidate and the current cross-component model are of the same cross-component prediction mode, the combined prediction is generated by computing weighted averages of model parameters of the selected cross-component model candidate and the current cross-component model.

The decoder generates (at block 1040) a combined prediction based on the first and second predictions. The combined prediction may be a weighted sum of the first prediction and the second prediction. The weights assigned to the first and second predictions are predefined, determined by neighboring prediction modes, or implicitly derived by neighboring template cost.

The decoder reconstructs (at block 1050) the current block using the generated combined prediction and received prediction residuals. The decoder may then provide the reconstructed current block for display as part of the reconstructed current picture.

### IX. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

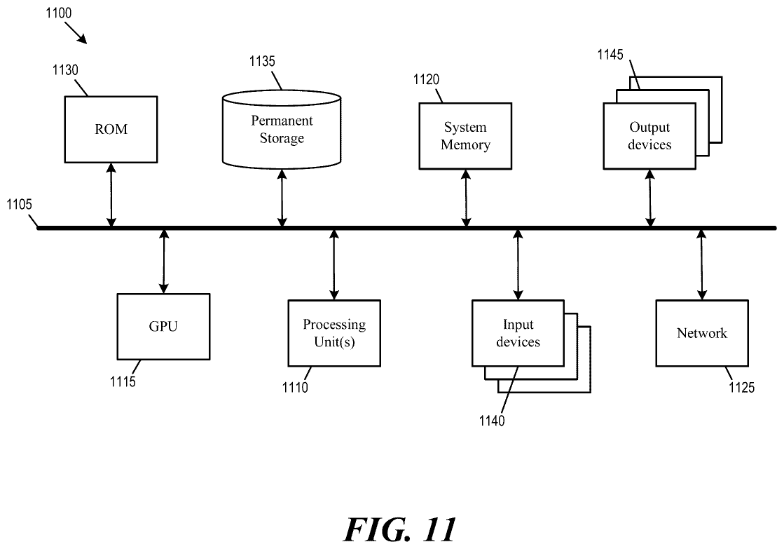

FIG. 11 conceptually illustrates an electronic system 1100 with which some embodiments of the present disclosure are implemented. The electronic system 1100 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1100 includes a bus 1105, processing unit(s) 1110, a graphics-processing unit (GPU) 1115, a system memory 1120, a network 1125, a read-only memory 1130, a permanent storage device 1135, input devices 1140, and output devices 1145.

The bus 1105 collectively represents all system, peripheral, and chipset buses that communicatively connect the numerous internal devices of the electronic system 1100. For instance, the bus 1105 communicatively connects the processing unit(s) 1110 with the GPU 1115, the read-only memory 1130, the system memory 1120, and the permanent storage device 1135.

From these various memory units, the processing unit(s) 1110 retrieves instructions to execute and data to process in order to execute the processes of the present disclosure. The processing unit(s) may be a single processor or a multi-core processor in different embodiments. Some instructions are passed to and executed by the GPU 1115. The GPU 1115 can offload various computations or complement the image processing provided by the processing unit(s) 1110.

The read-only-memory (ROM) 1130 stores static data and instructions that are used by the processing unit(s) 1110 and other modules of the electronic system. The permanent storage device 1135, on the other hand, is a read-and-write memory device. This device is a non-volatile memory unit that stores instructions and data even when the electronic system 1100 is off. Some embodiments of the present disclosure use a mass-storage device (such as a magnetic or optical disk and its corresponding disk drive) as the permanent storage device 1135.

Other embodiments use a removable storage device (such as a floppy disk, flash memory device, etc., and its corresponding disk drive) as the permanent storage device. Like the permanent storage fdevice 1135, the system memory 1120 is a read-and-write memory device. However, unlike storage device 1135, the system memory 1120 is a volatile read-and-write memory, such a random access memory. The system memory 1120 stores some of the instructions and data that the processor uses at runtime. In some embodiments, processes in accordance with the present disclosure are stored in the system memory 1120, the permanent storage device 1135, and/or the read-only memory 1130. For example, the various memory units include instructions for processing multimedia clips in accordance with some embodiments. From these various memory units, the processing unit(s) 1110 retrieves instructions to execute and data to process in order to execute the processes of some embodiments.

The bus 1105 also connects to the input and output devices 1140 and 1145. The input devices 1140 enable the user to communicate information and select commands to the electronic system. The input devices 1140 include alphanumeric keyboards and pointing devices (also called “cursor control devices”), cameras (e.g., webcams), microphones or similar devices for receiving voice commands, etc. The output devices 1145 display images generated by the electronic system or otherwise output data. The output devices 1145 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 11, bus 1105 also couples electronic system 1100 to a network 1125 through a network adapter (not shown). In this manner, the computer can be a part of a network of computers (such as a local area network (“LAN”), a wide area network (“WAN”), or an Intranet, or a network of networks, such as the Internet. Any or all components of electronic system 1100 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 7 and FIG. 10) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving data to be encoded or decoded as a current block of pixels of a current picture of a video;
generating a first prediction by a current cross-component model of the current block;
generating a second prediction using a cross-component model candidate selected from a list of cross-component model candidates for the current block;
generating a combined prediction based on the first prediction and the second prediction; and
encoding or decoding the current block using the generated combined prediction.

2. The video coding method of claim 1, wherein the combined prediction is a weighted sum of the first prediction and the second prediction.

3. The video coding method of claim 2, wherein weights assigned to the first and second predictions are predefined, determined by neighboring prediction modes, or implicitly derived by neighboring template cost.

4. The video coding method of claim 1, further comprising:
specifying a cross-component prediction mode for the current block;
deriving the current cross-component model according to the specified cross-component prediction mode for the current block;
identifying the list of cross-component model candidates for the current block; and
selecting the cross-component model candidate from the list of candidate cross-component models.

5. The video coding method of claim 4, wherein the current cross-component model is derived based on the neighboring reconstructed samples of the current block or predicted samples of the current block that are identified by the specified cross-component prediction mode.

6. The video coding method of claim 4, further comprising:
determining the specified cross-component prediction mode and whether to use the combined prediction to encode or decode the current block.

7. The video coding method of claim 6, wherein the determination is explicitly signaled by a first syntax element indicating the specified cross-component prediction mode and a second syntax element indicating whether to use the combined prediction to encode or decode the current block, wherein the first syntax element is signaled or parsed before the second syntax element.

8. The video coding method of claim 6, wherein when the combined prediction is used to encode the current block, the first candidate in the list of candidates is the selected cross-component model candidate.

9. The video coding method of claim 4, wherein the specified cross-component prediction mode is implicitly derived.

10. The video coding method of claim 1, further comprising:
determining whether the cross-component model candidate is used; and
determining whether to generate the combined prediction.

11. The video coding method of claim 10, wherein a first syntax element indicating whether to use the selected cross-component model candidate is explicitly signaled, and a second syntax element indicating whether to use the combined prediction to encode current block is explicitly signaled, wherein the first syntax element is signaled before the second syntax element.

12. The video coding method of claim 1, wherein the current cross-component model is set to be of a same cross-component prediction mode as that of the selected cross-component model.

13. The video coding method of claim 1, wherein when the selected cross-component model candidate and the current cross-component model are of the same cross-component prediction mode, the combined prediction is generated by computing weighted averages of model parameters of the selected cross-component model candidate and the current cross-component model.

14. The video coding method of claim 1, further comprising determining whether to use the combined prediction to encode or decode the current block based on a size constraint of the current block.

15. An electronic apparatus comprising:
a video coder circuit configured to perform operations comprising:
receiving data to be encoded or decoded as a current block of pixels of a current picture of a video;
generating a first prediction by a current cross-component model of the current block;
generating a second prediction using a cross-component model candidate selected from a list of cross-component model candidates for the current block;
generating a combined prediction based on the first prediction and the second prediction; and
encoding or decoding the current block using the generated combined prediction.

16. A video decoding method comprising:
receiving data to be decoded as a current block of pixels of a current picture of a video;
generating a first prediction by a current cross-component model of the current block;
generating a second prediction using a cross-component model candidate selected from a list of cross-component model candidates for the current block;
generating a combined prediction based on the first prediction and the second prediction; and
reconstructing the current block using the generated combined prediction.

17. A video encoding method comprising:
receiving data to be encoded as a current block of pixels of a current picture of a video;
generating a first prediction by a current cross-component model of the current block;
generating a second prediction using a cross-component model candidate selected from a list of cross-component model candidates for the current block;
generating a combined prediction based on the first prediction and the second prediction; and
encoding the current block using the generated combined prediction.
